(19) United States
(12) Patent Application Publication
(10) Pub. No.: US 2016/0150209 A1
(43) Pub. Date: May 26, 2016

(54) Depth Range Adjustment of a 3D Video to Match the Depth Range Permissible by a 3D Display Device

(71) Applicant: TELEFONAKTIEBOLAGET L M ERICSSON (PUBL), Stockholm (SE)

(72) Inventors: Mehdi Dadash Pour, Sundbyberg (SE); Beatriz Grafulla-Gonzàlez, Solna (SE)

(21) Appl. No.: 14/898,266

(22) PCT Filed: Jun. 19, 2013
(86) PCT No.: PCT/SE2013/050725

§ 371 Date: Dec. 14, 2015

(51) Int. Cl. H04N 13/00; H04N 13/04

(52) U.S. Cl. CPC H04N 13/0022; H04N 13/0497; H04N 13/0409

(57) ABSTRACT

A 3D video sequence is acquired. The 3D video sequence comprises left and right views of image pairs. A capturing parameter (depth range) of the 3D video sequence is acquired. A rendering capability parameter (screen size or allowable depth range) of a rendering device is acquired. A positional displacement between the left and right views of the image pairs in the 3D video sequence is determined based on the acquired rendering capability parameter and the acquired capturing parameter so as to enable adaptation of the 3D video sequence to the rendering device. The 3D video sequence and the positional displacement are provided to at least one of the rendering unit and a controller.

### TECHNICAL FIELD

Embodiments presented herein relate to video communication in general and particularly to a method, a device, a computer program, and a computer program product for enabling adaptation of a 3D video sequence.

### BACKGROUND

For video communication services, there is a challenge to obtain good performance and capacity for a given communications protocol, its parameters and the physical environment in which the video communication service is deployed.

In recent years, video conferencing has become an important tool of daily life. In the business environment, it enables a more effective collaboration between remote locations as well as the reduction of travelling costs. In the private environment, video conferencing makes possible a closer, more personal communication between related people. In general, although 2D video conferencing systems provide a basic feeling of closeness between participants, the user experience could still be improved by supplying a more realistic/immersive feeling to the conferees. Technically, this could be achieved, among others, with the deployment of 3D video, which adds depth perception to the user visual experience and also provides a better understanding of the scene proportions.

3D video conferencing may be enabled in many different forms. To this effect, 3D equipment such as stereo cameras and 3D displays have been deployed. 3D video or 3D experience commonly refers to the possibility of for a viewer, getting the feeling of depth in the scene or, in other words, to get a feeling for the viewer to be in the scene. In technical terms, this may generally be achieved both by the type of capture equipment (i.e. the cameras) and by the type of rendering equipment (i.e. the display) that are deployed in the system.

The user experience in 3D video conferencing depends, for example, on how the content is captured and displayed. There have previously been proposed mechanisms for adapting the transmitted 3D video stream for a comfortable experience, mainly in point-to-point calls, i.e. where only two clients are involved. However, this principle is not applicable in more complex scenarios such as multi-party calls (i.e. where three or more clients are involved).

Hence, there is still a need for an improved user experience in 3D video communications.

### SUMMARY

An object of embodiments herein is to provide improved user experience in 3D video communications.

The inventors of the enclosed embodiments have discovered that one issue with the existing mechanisms for improved user experience in 3D video communications are based on the fact that in multi-party calls the 3D stream adaptation is carried out for the worse case scenario, i.e. for the largest screen. The inventors of the enclosed embodiments have realised that this implies that for smaller screens the 3D user experience is poorer since the scene will look flatter. The inventors of the enclosed embodiments have therefore further realised that in order for each receiving client to have an optimized comfortable 3D user experience, the transmitted stream should be adapted individually to each client.

A particular object is therefore to provide improved user experience in 3D video communications based on individually adapted 3D video sequences.

According to a first aspect there is presented a method for enabling adaptation of a 3D video sequence. The method is performed by an electronic device. The method comprises acquiring a 3D video sequence, the 3D video sequence comprising left and right views of image pairs. The method comprises acquiring a capturing parameter of the 3D video sequence. The method comprises acquiring a rendering capability parameter of a rendering device. The method comprises determining a positional displacement between the left and right views of the image pairs in the 3D video sequence based on the acquired rendering capability parameter and the acquired capturing parameter so as to enable adaptation of the 3D video sequence to the rendering device. The method comprises providing the 3D video sequence and the positional displacement to at least one of the rendering unit and a controller.

Advantageously this provides improved user experience in 3D video communications.

Further advantageously this enables adapting 3D video streams to all different types of clients. Thus, even when multiple clients are participating in a call, all clients will have an optimized comfortable 3D user experience independently of the rendering device deployed.

According to a second aspect there is presented an electronic device for enabling adaptation of a 3D video sequence. The electronic device comprises a processing unit. The processing unit is arranged to acquire a 3D video sequence, the 3D video sequence comprising left and right views of image pairs. The processing unit is arranged to acquire a capturing parameter of the 3D video sequence. The processing unit is arranged to acquire a rendering capability parameter of a rendering device. The processing unit is arranged to determine a positional displacement between the left and right views of the image pairs in the 3D video sequence based on the acquired rendering capability parameter and the acquired capturing parameter so as to enable adaptation of the 3D video sequence to the rendering device. The processing unit is arranged to provide the 3D video sequence and the positional displacement to at least one of the rendering unit and a controller.

According to a third aspect there is presented a 3D video conference system comprising at least two electronic devices according to the second aspect.

According to a fourth aspect there is presented a computer program for enabling adaptation of a 3D video sequence. The computer program comprises computer program code which, when run on an electronic device, causes the electronic device to perform a method according to the first aspect.

According to a fifth aspect there is presented a computer program product comprising a computer program according to the fourth aspect and a computer readable means on which the computer program is stored. The computer readable means may be non-volatile computer readable means.

It is to be noted that any feature of the first, second, third, fourth and fifth aspects may be applied to any other aspect, wherever appropriate. Likewise, any advantage of the first aspect may equally apply to the second, third, fourth, and/or fifth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the inventive concept will now be described, by way of non-limiting examples, references being made to the accompanying drawings, in which:

FIG. 1 is a schematic diagram illustrating a video communications system according to an embodiment;

FIG. 2a is a schematic diagram showing functional modules of an electronic device representing a video conferencing client device according to an embodiment;

FIG. 2b is a schematic diagram showing functional modules of an electronic device representing a central controller according to an embodiment;

FIG. 3a is a schematic diagram showing functional units of a memory according to an embodiment;

FIG. 3b is a schematic diagram showing functional units of a memory according to an embodiment;

FIG. 4 shows one example of a computer program product comprising computer readable means according to an embodiment;

FIG. 5 is a schematic diagram illustrating a parallel sensor-shifted setup according to an embodiment;

FIG. 6 is a schematic diagram illustrating stereo display setup according to an embodiment;

FIG. 7 is a schematic diagram illustrating stereo framing violation areas according to an embodiment;

FIG. 8 is a schematic diagram illustrating depth budgets and depth brackets according to embodiments; and

FIGS. 9, 10, 11, 12, and 13 are flowcharts of methods according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

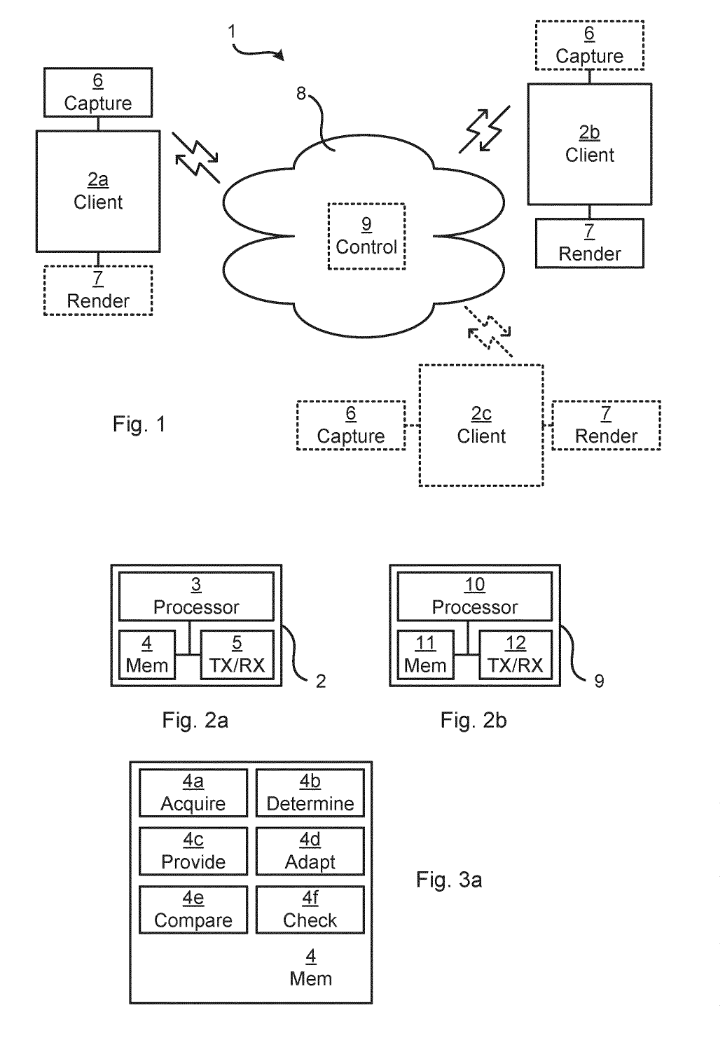

FIG. 1 is a schematic diagram illustrating a video communications system la where embodiments presented herein can be applied. The video communications system 1a comprises a number of electronic devices 2a, 2b, 2c representing video conferencing client devices. The electronic devices 2a, 2b, 2c are operatively connected via a communications network 8. The communications network 8 may comprise an electronic device 9 representing a central controller. The central controller may be arranged to control the communications between the video conferencing client devices.

Each electronic device 2a, 2b, 2c representing a video conferencing client device comprises, or is operatively connected to, a 3D video sequence capturing unit 6 (i.e. one or more cameras) and/or a 3D video sequence rendering unit 7 (i.e. a unit, such as a display, for rendering received video sequences) that require different video formats and codecs. As the skilled person understands this are just one example of a video communications system where the disclosed embodiments can be applied Thus, although only three electronic devices 2a, 2b, 2c representing video conferencing client devices are illustrated in FIG. 1, there may in practical situations be a large combination of electronic devices 2a, 2b, 2c representing video conferencing client devices with different 2D/3D equipment.

The central controller may be arranged to only route/switch received video sequences. In this case, the video conferencing client devices transmit multiple video sequences with different resolutions, e.g. a high-quality video sequence for the main speaker case and low-quality video sequences for the thumbnails cases. The central controller then decides which video sequence is sent to which video conferencing client device, depending on the main speaker and the video conferencing client device itself. The central controller may alternatively be arranged to transcodes and/or re-scales received video sequences. In this case, the video conferencing client devices only transmit one high-quality video sequence which is processed by the central controller depending on whether the video sequence represents the main speaker or a thumbnail. Then, the central controller transmits the correct video sequence resolution to the each video conferencing client device. The central controller may yet alternatively be arranged to mix the video sequences. In this case, the central controller decodes the received video sequences and composes the rendering scene depending on the main speaker and thumbnails. This implies that video sequences are transcoded and/or re-scaled. Then, the central controller transmits the composed video sequences to the video conferencing client devices, which only have to render the received video sequence.

The inventive concept relate to enabling all clients participating in a 3D multi-party call to have an optimized comfortable 3D user experience. More particularly, the embodiments disclosed herein relate to enabling adaptation of a 3D video sequence. In order to obtain enabling adaptation of a 3D video sequence there is provided an electronic device, a method performed by the electronic device, a computer program comprising code, for example in the form of a computer program product, that when run on an electronic device, causes the electronic device to perform the method.

FIG. 2a schematically illustrates, in terms of functional modules, an electronic device 2 representing a video conferencing client device. The electronic device 2 may be part of a stationary computer, a laptop computer, a tablet computer, or a mobile phone. A processing unit 3 is provided using any combination of one or more of a suitable central processing unit (CPU), multiprocessor, microcontroller, digital signal processor (DSP), application specific integrated circuit (ASIC) etc., capable of executing software instructions stored in a computer program product 13 (as in FIG. 4). Thus the processing unit 3 is thereby preferably arranged to execute methods as herein disclosed. The electronic device 2 further comprises an input/output (I/O) interface in the form of a transmitter (TX) 4 and a receiver (RX) 5, for communicating with other electronic devices over the communications network 8, with a capturing unit 6 and a display unit 7. Other components, as well as the related functionality, of the electronic device 2 are omitted in order not to obscure the concepts presented herein.

FIG. 2b schematically illustrates, in terms of functional modules, an electronic device 9 representing a central controller. The electronic device 9 is preferably part of a network server functioning as media resource function processor (MRFP), but may also be part of a stationary computer, a laptop computer, a tablet computer, or a mobile phone acting as a host for a 3D video communication service. A processing unit 10 is provided using any combination of one or more of a suitable central processing unit (CPU), multiprocessor, microcontroller, digital signal processor (DSP), application specific integrated circuit (ASIC) etc., capable of executing software instructions stored in a computer program product 13 (as in FIG. 4), Thus the processing unit 10 is thereby preferably arranged to execute methods as herein disclosed. The central device 9 further comprises an input/output (I/O) interface in the form of a transmitter (TX) 11 and a receiver (RX) 12, for communicating with electronic devices 2a, 2b, 2c representing video conferencing client devices over the communications network 8. Other components, as well as the related functionality, of the electronic device 9 are omitted in order not to obscure the concepts presented herein.

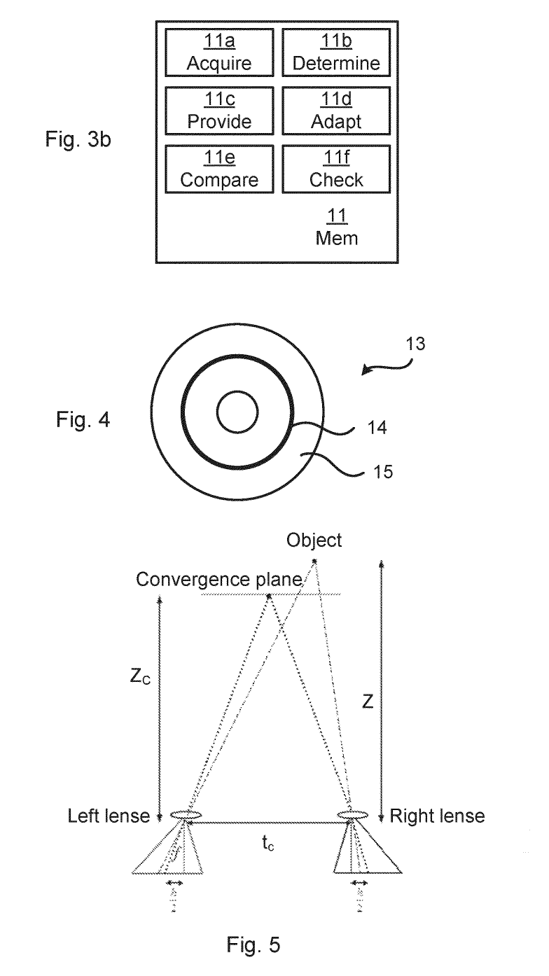

FIG. 3a schematically illustrates functional units of the memory 4 of the electronic device 2; an acquiring unit 4a, a determining unit 4b, a providing unit 4c, an adapting unit 4d, a comparing unit 4e, and a checking unit 4f. The functionality of each functional unit 4a-f will be further disclosed. In general terms, each functional unit 4a-f may be implemented in hardware or in software. The processing unit 3 may thus be arranged to from the memory 4 fetch instructions as provided by a functional unit 4a-f and to execute these instructions.

FIG. 3b schematically illustrates functional units of the memory 11 of the electronic device 9; an acquiring unit 11a, a determining unit 11b, a providing unit 11c, an adapting unit 11d, a comparing unit lie, and a checking unit 11f. The functionality of each functional unit 11a-f will be further disclosed. In general terms, each functional unit 11a-f may be implemented in hardware or in software. The processing unit 10 may thus be arranged to from the memory 11 fetch instructions as provided by a functional unit 11a-f and to execute these instructions.

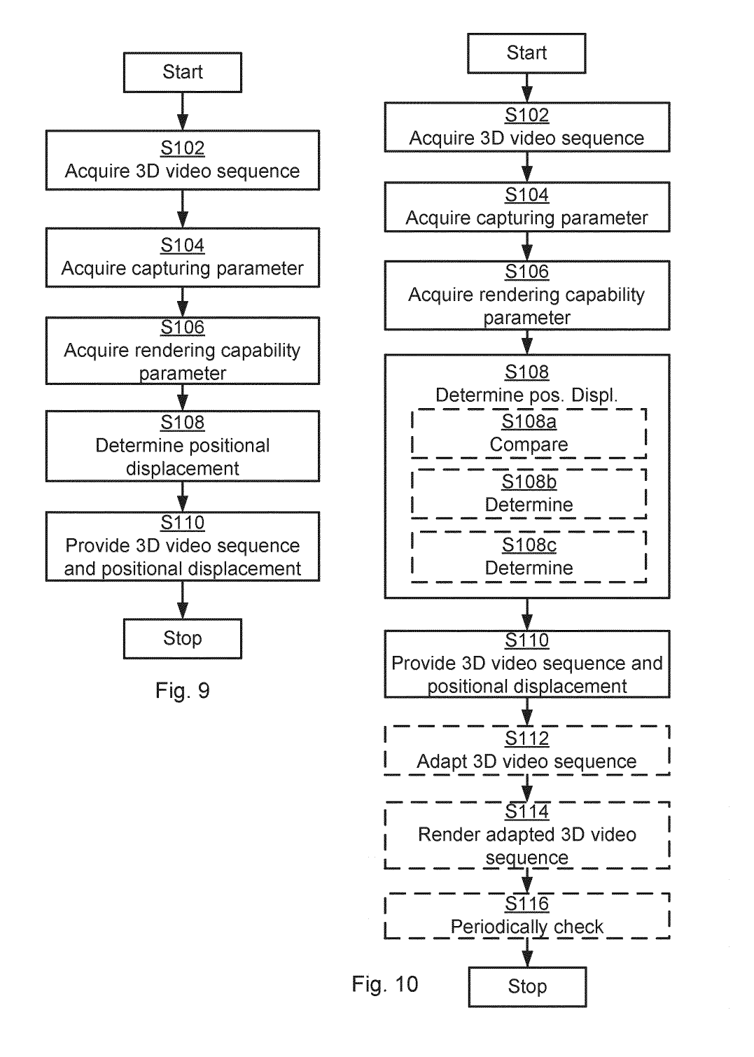

FIGS. 9, 10, 11, 12, and 13 are flowcharts illustrating embodiments of methods for enabling adaptation of a 3D video sequence. The methods are performed by an electronic device 2, 9 representing a video conferencing client device (as in FIG. 2) or a central controller (as in FIG. 3). The methods are advantageously provided as computer programs 14. FIG. 4 shows one example of a computer program product 13 comprising computer readable means 15. On this computer readable means 15, a computer program 14 can be stored. This computer program 14 can cause the processing unit 3 of the electronic device 2 and thereto operatively coupled entities and devices to execute methods according to embodiments described herein. The computer program 14 can alternatively or additionally cause the processing unit 10 of the electronic device 9 and thereto operatively coupled entities and devices to execute methods according to embodiments described herein. The computer program 14 and/or computer program product 13 thus provides means for performing any steps as herein disclosed.

In the example of FIG. 4, the computer program product 13 is illustrated as an optical disc, such as a CD (compact disc) or a DVD (digital versatile disc) or a Blu-Ray disc. The computer program product 13 could also be embodied as a memory (RAM, ROM, EPROM, EEPROM) and more particularly as a non-volatile storage medium of a device in an external memory such as a USB (Universal Serial Bus) memory. Thus, while the computer program 14 is here schematically shown as a track on the depicted optical disk, the computer program 14 can be stored in any way which is suitable for the computer program product 13.

For the capturing side, it is assumed that the capturing units 6 are configured with the so-called parallel sensor-shifted setup, as illustrated in FIG. 5. Other configurations, such as the so-called toed-in setup, are possible too, although extra processing would be required to align left and right views, in general terms yielding a worse stereoscopic quality.

In FIG. 5, f denotes the capturing unit's camera focal length, t_{c} is the baseline distance (or the distance between the camera optical centers), and Z_{C} is the distance to the convergence plane or the convergence distance. In the parallel sensor-shifted setup, the convergence of cameras is established by a small shift (h/2) of the sensor targets. Suppose the captured object is on the distance (i.e. depth) Z from the cameras. The distance between the image points in the left and the right images that refer to the same captured point is called the disparity d.

The parameters mentioned above are mathematically related and it is not difficult for a skilled person to derive the following expression that connects them:

$$d = h - \frac{{t}_{c} f}{Z} = {t}_{c} f ( \frac{1}{{Z}_{C}} - \frac{1}{Z} ) \qquad ( 1 )$$

Objects captured at Z=Z_{C} have zero disparity, which further yields:

$$h = \frac{{t}_{c} f}{{Z}_{C}} \qquad ( 2 )$$

In a similar way, objects captured at Z<Z_{C} have negative disparity, and objects captured at Z>Z_{C} have a positive disparity.

There is hence not a single disparity for the whole stereo pair (i.e. the corresponding left and right views), but rather a set of disparities. Indeed, disparity is the distance between the image points in the left and right images that refer to the same captured point. Hence there will be as many disparities as matched points between the views.

3D displays (as part of the rendering unit) create the feeling of depth by showing simultaneously two slightly different images for the left and the right eye. One parameter that controls the depth perception is the so-called screen parallax P, which reflects the spatial distance between the points in the left and right views on the screen. In general terms, the depth perception, among other parameters, depends on the amount and type of parallax. The so-called positive parallax means that the point in the right-eye view lays more right than the corresponding point in the left-eye view. Zero parallax means that the points lay at the same position, while negative parallax means that the point in the right-eye view lays more left than the corresponding point in the left-eye view. With positive parallax the objects are perceived in the so-called screen space, whereas with zero and negative parallax they are perceived on and in front of the screen space (viewer space) respectively.

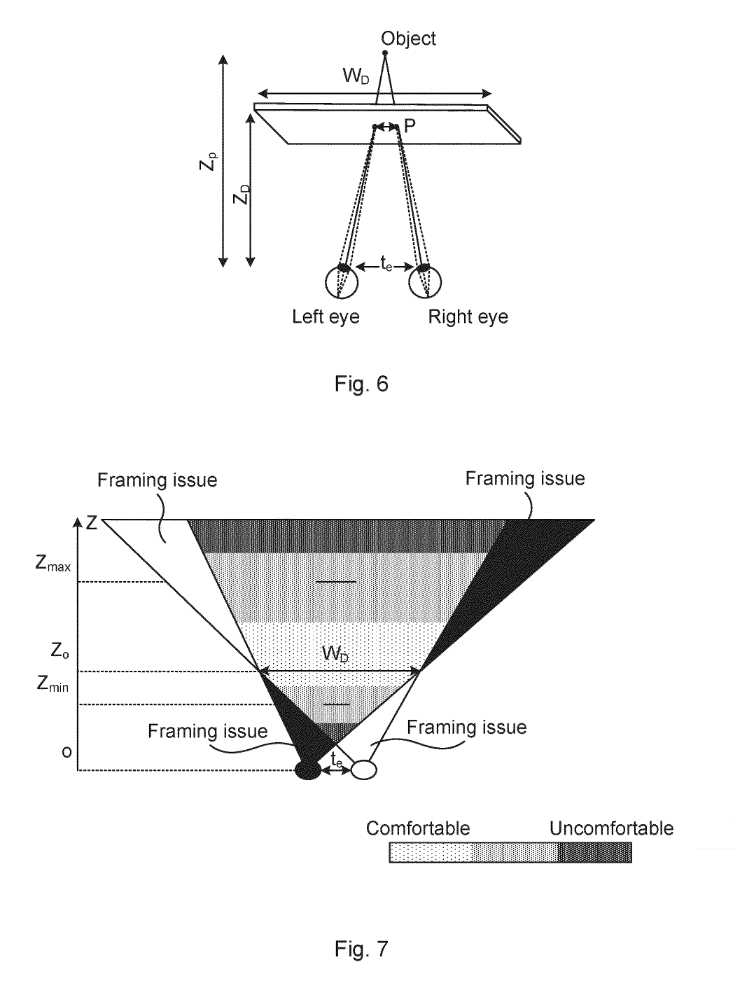

Suppose, without limitation, that the distance between the viewers eyes is tₑ (the so-called inter-ocular distance) and that the viewer sits at a distance Z_{D} from the screen, as schematically illustrated in FIG. 6. A simple geometric study yields the following expression for the perceived depth:

$${Z}_{p} = \frac{{Z}_{D} \cdot {t}_{e}}{{t}_{e} - P} \qquad ( 3 )$$

From this equation it follows that objects with a positive parallax are perceived to be in the screen space (Zₚ>Z_{D}), objects with zero parallax exactly on the screen surface (Zₚ=Z_{D}), and objects with negative parallax in the viewer space (Zₚ<Z_{D}).

A 3D display is characterized with a parallax range [P_{DB min},P_{DB max}] for which 3D viewing is comfortable for a user and which indeed defines the depth budget.

The maximum value of parallax that human eyes can handle without diverging is equal to the inter-ocular distance, i.e. P_{DB max}=tₑ. This is, however, a border case, which usually does not hold in real stereo setups, where the furthest objects are usually placed at some distance comfortable for the viewers.

The minimum value of the parallax can be approximated by:

P_{DB min}=tₑ−Z_{D}·Δαₜₒₜₐₗ, where Δαₜₒₜₐₗ is the total convergence angle that itself is the sum of the two convergence ranges—one for the viewer space in front of the display and one for the screen space behind the display. An established rule of thumb is to set Δαₜₒₜₐₗ to 0.02 rad. Although conservative from the current knowledge point of view, this bound yields a safe estimate. A screen may have other recommended values for P_{DB min}. Indeed, another recommendation could be to limit the depth budget to 1/30 of the display width to avoid stereoscopic problems.

Screen parallax values that are outside the recommended parallax range may be tolerated for short periods of time, but they are not recommended for extended viewings as they would lead to discomfort and fatigue.

When rendering 3D video, there is not one single parallax for a rendered stereo pair, but rather a set of parallaxes (as for the disparities in the production side). The value range of achieved parallaxes defines the depth bracket.

During capturing and rendering of 3D video, various factors may affect the 3D user experience. Three examples that could produce a poor 3D experience are the accommodation-convergence rivalry, the comfortable viewing range and depth budget violation, and the stereo framing violation.

Accommodation-convergence rivalry has been studied in the literature. In a real scenario, eyes would simultaneously change ocular focus (accommodation) and ocular alignment (convergence) to generate the vision of a scene interest point. These two oculomotor mechanisms are linked together, i.e. converging on a specific object would result in automatic focus on its position. However, in a stereoscopic 3D display, perception of an object's depth is achieved by the amount of produced parallax. Although eyes try to converge on objects (as it would be in a real scenario), they are actually forced to focus on the screen plane (Z_{D}) instead of focusing on the object point (Zₚ), as shown in FIG. 6. Since accommodation and convergence are related, eyes try to focus on the apparent depth instead of the real depth. The result is an out of focus feeling of objects that appear closer to the viewer. This conflict could cause major eyestrain, confusion and loss of stereo vision. To eliminate this problem, the produced depth should be in a rather small volume around the screen plane.

Comfortable viewing range and depth budget are other criteria that could be considered while producing 3D video content. In a real scenario, the depth perception for a stereo content is achieved by the retinal disparity. If the retinal disparity of an object is too large, the binocular fusion fails and a pair of monocular objects might be perceived. An exaggerated positive or negative disparity in stereoscopic content can lead to this issue. In particular, an extreme positive disparity would force the eyes to diverge beyond infinity, whereas an extreme negative disparity would force the eyes to converge over their limit. To ensure that reconstruction of scene elements do not result in an unnatural eye movement, a limited depth budget close to screen could be targeted (as for accommodation-convergence rivalry). This limited depth range is called Comfortable Viewing Range (CVR) and is dependent on different parameters, such as the viewing distance Z_{D}, the display width W_{D} and the accommodation-convergence rivalry.

Stereo framing violation generally occurs when a scene object is only contained in one of the views (either the left or the right view), most likely because it was located at the scene boundary which has been cut off. As shown in FIG. 7, each eye has an associated field of view, illustrated by the black and white cones, respectively, and determined by the position of the eye and the display. If an object is displayed at the retinal rivalry area (i.e. where the black and white cones are not overlapping), the object is only presented to one eye. It produces hence a conflict between two different depth cues: the monocular depth cue suggests that the object should be behind the screen because it is occluded by the screen boundaries, whereas the binocular depth cue suggests that the object should be in front of the screen due to the introduced negative parallax. The scene parts that are only shown to one view appear as transparent objects and watching these areas causes eye divergence.

The inventive concept relate to enabling all video conferencing client device participating in a 3D multi-party call to have a comfortable 3D user experience. Since it is likely that each video conferencing client device has different type of capturing units 6 and rendering units 7, and in particular different 3D screen sizes, it may be required that the transmitted 3D video sequences are adapted individually to each video conferencing client device. Herein are hence proposed different embodiments to adapt a transmitted 3D video sequence to each video conferencing client device in order to provide a user comfortable 3D experience for each receiving video conferencing client device. To this effect, a method for enabling adaptation of a 3D video sequence having different embodiments which are based on a shift (a positional displacement) between the left and right views of a stereo pair are disclosed. The method is performed by an electronic device 2, 2a, 2b, 2c, 9. The shift may be determined for each video conferencing client device individually. As will be further disclosed below the determination of the shift may be performed either at the capturing side, at the rendering side or at the central controller. Different type of metadata could be communicated between the video conferencing client devices and the central controller, either at the beginning of or during the call.

The processing unit 3, 10 of the electronic device 2, 2a, 2b, 2c, 9 is arranged to, in a step S102, acquire a 3D video sequence. These instructions may be provided by the acquiring units 4a, 11a. Hence the acquiring units 4a, 11a may be configured to acquire the 3D sequence. The computer program 14 and/or computer program product 13 may thus comprise means for performing instructions according to step S102. The 3D video sequence comprises left and right views of image pairs. Hence, the 3D video sequence may be represented as a sequence of stereo image pairs. The processing unit 3, 10 of the electronic device 2, 2a, 2b, 2c, 9 is arranged to, in a step S104, acquire a capturing parameter of the 3D video sequence. These instructions may be provided by the acquiring units 4a, 11a. Hence the acquiring units 4a, 11a may be configured to acquire the capturing parameter. The computer program 14 and/or computer program product 13 may thus comprise means for performing instructions according to step S104. Examples of such capturing parameters and how they may be used will be further disclosed below. The processing unit 3, 10 of the electronic device 2, 2a, 2b, 2c, 9 is arranged to, in a step S106, acquire a rendering capability parameter of a rendering device. These instructions may be provided by the acquiring units 4a, 11a. Hence the acquiring units 4a, 11a may be configured to acquire the rendering capability parameter. The computer program 14 and/or computer program product 13 may thus comprise means for performing instructions according to step S106. Examples of such rendering capability parameters and how they may be used will be further disclosed below. Based on the acquired rendering capability parameter and the acquired capturing parameter the processing unit 3, 10 of the electronic device 2, 2a, 2b, 2c, 9 is arranged to, in a step S108, determine a positional displacement between the left and right views of the image pairs in the 3D video sequence. These instructions may be provided by the determination units 4b, 11b. Hence the determination units 4b, 11b may be configured to determine the positional displacement. The computer program 14 and/or computer program product 13 may thus comprise means for performing instructions according to step 108. This positional displacement enables adaptation of the 3D video sequence to the rendering device. Then, the processing unit 3, 10 of the electronic device 2, 2a, 2b, 2c, 9 is arranged to, in a step S110, provide the 3D video sequence and the positional displacement to at least one of the rendering unit and a controller. These instructions may be provided by the providing units 4c, 11c. Hence the providing units 4c, 11c may be configured to provide the 3D video sequence and the positional displacement. The computer program 14 and/or computer program product 13 may thus comprise means for performing instructions according to step S110.

According to one embodiment the steps as herein disclosed are performed in real-time. Hence, the herein disclosed mechanisms for 3D video sequence depth parameter determination are readily applicable in 3D video conferencing systems.

According to one embodiment the electronic device comprises at least one of a 3D video sequence capturing unit 6 arranged to capture the 3D image video sequence, and a 3D video sequence rendering unit 7 arranged to render the 3D image video sequence. The electronic device may further comprise a communications interface 12 arranged to receive the 3D image video sequence from a 3D video sequence capturing unit device 6, and to transmit the 3D image video sequence to a 3D video sequence rendering unit device 7. As noted above, the electronic device 2 may represent a video conferencing client device. The electronic device may thus either be located at the capturing side or the rendering side. As also noted above, the electronic device 9 may alternatively represent a central controller. According to one embodiment the electronic device is thus located in the communications network 8. Particularly, if steps S102-S108 have been performed at the capturing side (i.e., by an electronic device 2a, 2b, 2c representing a video conferencing client device) the 3D video sequence and the positional displacement may be provided to a central controller. That is, according to one embodiment the 3D image sequence is acquired from the capturing device 6 having captured the 3D image sequence. Particularly, if steps S102-S108 have been performed by an electronic device 9 representing a central controller the 3D video sequence and the positional displacement may be provided to the rendering side (i.e., to an electronic device 2a, 2b, 2c representing a video conferencing client device). Particularly, if steps S102-S108 have been performed at the rendering side (i.e., by an electronic device 2a, 2b, 2c representing a video conferencing client device) the 3D video sequence and the positional displacement may be provided to a rendering unit 7. That is, according to one embodiment the 3D image sequence is acquired from a central controller, such as from the central controller. Further, also the rendering capability parameter may be acquired from the central controller.

According to one embodiment the processing unit 3, 10 is further arranged to, in an optional step S112, adapt the 3D video sequence based on the positional displacement so as to generate an adapted 3D video sequence. These instructions may be provided by the adapting units 4d, 11d. Hence the adapting units 4d, 11d may be configured to adapt the 3D video sequence. The computer program 14 and/or computer program product 13 may thus comprise means for performing instructions according to step S112. Once the 3D video sequence has been adapted based on the positional displacement the adapted 3D video sequence may be rendered. The rendering unit 7 may therefore be arranged to, in an optional step S114, render the adapted 3D video sequence.

According to one embodiment the capturing parameter is based on the depth bracket of the 3D image sequence. The capturing parameter can also be referred to as a more general parameter of the capturing device (such as focal length, baseline, etc.), whereas depth bracket can be described as the specification of the captured 3D video sequence with respect to a capturing device parameter. According to one embodiment the rendering capability parameter is based on at least one of the screen size and depth budget of the rendering device.

Three overall embodiments related to the positional displacement will now be disclosed.

In a first overall embodiment, the video conferencing client devices signal their screen width and/or depth budget to the central controller. The central controller stores the data from each video conferencing client device in a data base. The central controller makes the data base available to all video conferencing client devices. Then each video conferencing client device receives the information stored in the data base either from an update from the central controller or by requesting it from the central controller. Based on the other screen sizes and its own capturing parameters, each video conferencing client device is able to determine the necessary shift required for all the other video conferencing client devices. The shift is determined by comparing the depth budget of each video conferencing client device and its own depth bracket (or equivalently its own produced disparity range). Finally, the all video conferencing client device transmits both the captured 3D video sequence without modifications and the determined shifts as metadata. The other video conferencing client devices receive such a 3D video sequence with the metadata, and adapt the 3D video sequence based on the determined shift for its rendering capabilities.

In a second overall embodiment, each video conferencing client device transmits, together with its captured 3D video sequence, its own depth bracket (or equivalently its own produced disparity range). All the receiving video conferencing client devices can hence determine the required shift based on the received depth bracket and its own rendering capabilities (i.e. display width and depth budget). Alternatively, each video conferencing client device transmits only its captured 3D video sequence. Then, the receiving video conferencing client devices determine the depth bracket for each received 3D video sequence as well as the required shift based on this depth bracket and its own rendering capabilities (i.e. display width and depth budget). According to this second overall embodiment, each video conferencing client device keeps locally the list with the shifts for all other video conferencing client devices. Then, when the video conferencing client device knows which 3D vide sequence is received, it applies the correct shift. Once the shifts are determined, the depth bracket needs not to be transmitted or determined. Only the central controller needs to signal which 3D video sequence is being transmitted to the video conferencing client device so that each video conferencing client device can apply the correct shift.

In a third overall embodiment, the central controller receives the metadata from each video conferencing client device regarding their transmission and reception capabilities (e.g., depth bracket, depth budget and display width), and establishes the shifts for each video conferencing client device. During the call, the central controller adapts the 3D video sequence for each video conferencing client device. This implies that video conferencing client devices do not have to adapt the 3D video sequences, neither when transmitting nor when receiving. This implies transcoding at the central controller, which may introduce some delays. However, performing the processing by the central controller enables interoperability between different types of video conferencing client devices, thus enabling a flexible video communications system.

Particular details of the first overall embodiment, the second overall embodiment, and the third overall embodiment will now be disclosed in further detail.

### First Overall Embodiment

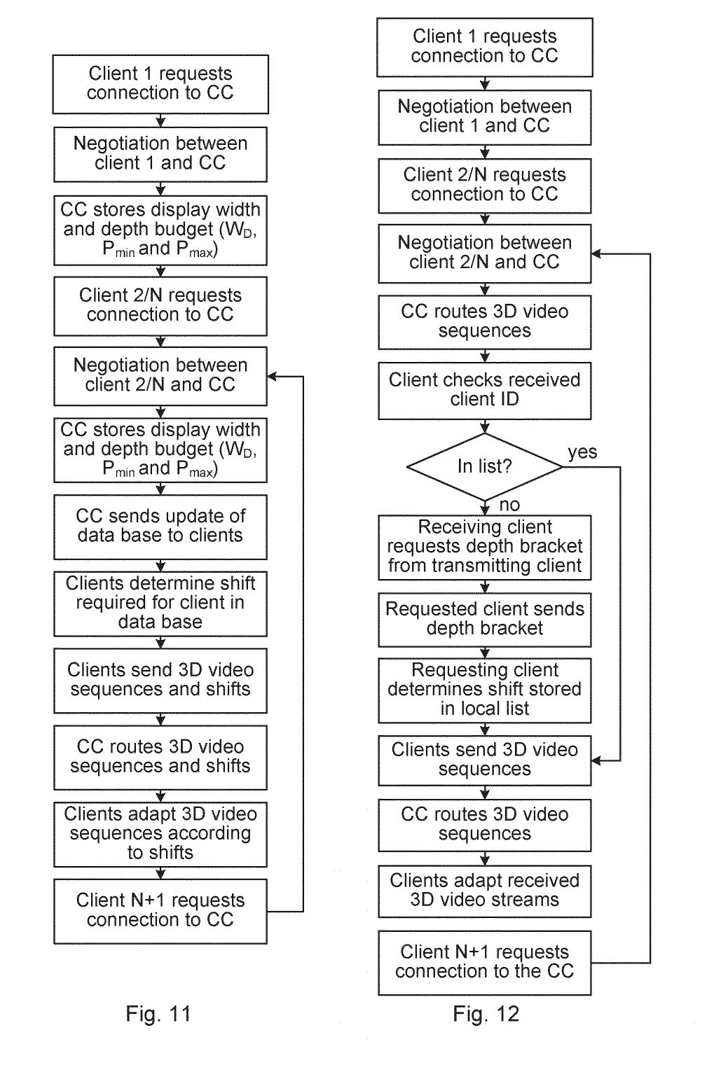

FIG. 11 is a flowchart of methods according to the first overall embodiment (where CC is short for central controller). The first overall embodiment may be divided into four main parts: an initial phase where rendering capabilities are stored for subsequent adaptation of the 3D video sequence; a shift determination; on-call modifications; and disconnection. The processing of the first overall embodiment is as follows:

Initial Phase

The first video conferencing client device (hereinafter a first client, as represented by a first video conferencing client device 2a) requests a connection to a multi-party video conference. The connection request is sent by the communications interface 5 of the electronic devices 2a representing the first video conferencing client device. The connection request may be sent to an electronic device 9 representing a central controller, such as an MRFP.

The first client and the central controller negotiate connection properties, such as audio and video codecs, for example through SIP/SDP (Session Initiation Protocol/Session Description Protocol) negotiation or according to other protocols, such as H.323. During the negotiation, the first client also signals its rendering capabilities (i.e. its 3D screen width, W_{D}) and/or the depth budget for this screen (i.e. Pₘᵢₙ and Pₘₐₓ). If the depth budget is not signaled, then the central controller considers a default case which corresponds to Pₘₐₓ=tₑ and Pₘᵢₙ=tₑ−Z_{D}·Δαₜₒₜₐₗ where Z_{D} is an either known or estimated display parameter (as described above).

The central controller also assigns the first client with a unique ID, e.g. “client 1”. The central controller stores the client ID in the memory 11. Once the connection between the first client and the central controller is performed, the central controller stores the values of W_{D}, Pₘᵢₙ and Pₘₐₓ (if available) for this client ID in a remote data base.

The first client starts transmitting the captured video to the central controller. Thus, a 3D video sequence is captured by the capturing unit 6 of the electronic devices 2a representing the first video conferencing client device 2a and the transmitted by its communications interface 5. The 3D video sequence is then received through the communications interface 12 of the electronic devices 9 representing the central controller. At this point it is, however, assumed that no other clients are connected to the 3D video conference. The central controller may thus disregard the received 3D video sequence and not transmit any 3D video sequences to the clients. For example, the processing unit 3 may be arranged to on the rendering unit 7 display a message indicating the lack of other connected clients.

Then another client (hereinafter a second client, as represented by a second video conferencing client device 2b) requests a connection to the central controller.

The same SIP/SDP negotiation (or any other negotiation protocol) takes place between the central controller and the second client. That is, the second client also signals its rendering capabilities (i.e. its 3D screen width, W_{D}) and/or the depth budget for this screen (i.e. Pₘᵢₙ and Pₘₐₓ). Likewise, if the depth budget is not signaled, then the central controller considers the default case which corresponds to Pₘₐₓ=tₑ and Pₘᵢₙ=tₑ−Z_{D}·Δαₜₒₜₐₗ where Z_{D} is an either known or estimated display parameter (as described above). Then, the central controller assigns the second client with a unique ID, e.g. “client 2” or “client N”.

Once the connection between the second client and the central controller is performed, the central controller stores the values of W_{D}, Pₘᵢₙ and Pₘₐₓ (if available) for this client ID in the remote data base.

As the skilled person understands, also at least one further client may join the 3D video conference according to the steps as outlined above.

At this point, the central controller recognizes that other client(s) is(are) connected to the multi-party call and therefore transmits the content of the remote data base to all the connected clients.

The clients connected so far receive the content of such a data base and determine the shift required for each client in the data base. The clients store locally a list with the client ID, the corresponding screen width and the corresponding shift to be applied.

As soon as the shifts are determined, the clients start transmitting their captured 3D video sequences (which is not modified in any way) as well as the list comprising the shift information. This latter may be transmitted in the form of 3D video sequence metadata, e.g. in the SEI messages of the video codec.

The central controller routes/switches the 3D video sequences as well as the corresponding SEI messages to the correct client(s).

Then each client adapts the received 3D video sequence according to the corresponding shift in the metadata and renders the content, which will thus have an individually adapted perceived depth at all connected clients.

A variation within the first overall embodiment concerns the way the clients receive the information from the data base. As outlined above, the central controller recognizes the addition of a new client to the data base, and hence sends an update to the clients. If the central controller has a more passive role, then it is the responsibility of each client to request an update of the data base. Once the central controller starts routing/switching the 3D video streams to the correct client the client therefore checks whether it has the receiving client ID in its local shift list. If the ID is in its list, clients start transmitting their captured 3D video sequences, as outlined above. However, if the client ID is not in its list, then the client requests an update of the central controller data base information and determines the shifts for the new client(s) in the data base. Then it stores the new values for the client ID, the corresponding screen width and the corresponding shift to be applied in its local list. In this case the shifts are not available immediately since first the client needs to identify that the newer client is not in its list and then the client needs to request the information from the data base. Therefore, when this happens, a zero shift (i.e. no shift) is applied provisionally until the actual shift to be used is received from the data base. One advantage of this variation is that the central controller has a passive role, thereby enabling faster routing/switching.

Shift Determination

In general terms, 3D video capturing and rendering sides are linked by a magnification factor S_{M}:

$${S}_{M} = \frac{P}{d} = \frac{{W}_{D}}{{W}_{S}} , \qquad ( 4 )$$

where d is the disparity the capturing side, P is the screen parallax on the rendering side, where W_{D} is the rendering screen width, and where W_{S} is the capturing sensor width. By introducing S_{M}, the capturing side and rendering side geometries can be combined. In this sense the depth bracket may be translated into the capturing side, where the produced disparity range is defined.

In general terms, the way the shift is determined may depend on the signaled depth budget and the own depth bracket (or produced disparity range). As explained above, depth budget corresponds to the parallax range where the 3D video is comfortable, whereas the depth bracket is the range of the captured disparities. Typically, depth budget is given for the rendering side while depth bracket is calculated at the capturing side. Since the shift is determined at the capturing side according to this first overall embodiment, the first step is to transform the depth budget to values at the capturing side. To this effect, Equation (4) may be utilized, where Pₘᵢₙ and Pₘₐₓ are transformed into dₘᵢₙ and dₘₐₓ such that:

$$\begin{matrix}{d}_{m i n} = \frac{{P}_{m i n}}{{S}_{M}} = {P}_{m i n} \frac{{W}_{S}}{{W}_{D}} & ( 5 ) \\ {d}_{ma x} = \frac{{P}_{ma x}}{{S}_{M}} = {P}_{m ax } \frac{{W}_{S}}{{W}_{D}} & ( 6 )\end{matrix}$$

where S_{M} thus is the magnification factor, W_{S} is the sensor width and W_{D} is the screen width, as above.

Once the depth budget and depth bracket values are obtained at the capturing side, the client can perform multiple strategies to determine the shift.

According to one embodiment the processing unit 3, 10 is thus further arranged to, in an optional step S108a, determine the positional displacement by comparing the depth budget of the rendering device 7 with the depth bracket of the 3D video sequence as produced by the capturing device 6 of the 3D video sequence. These instructions may be provided by the comparing units 4e, 11e. Hence the comparing units 4e, 11e may be configured to the depth budget. The computer program 14 and/or computer program product 13 may thus comprise means for performing instructions according to step S108a. The strategy chosen generally depends on whether the depth bracket range is smaller, the same, or larger than the depth budget. Each one of these cases will be handled next.

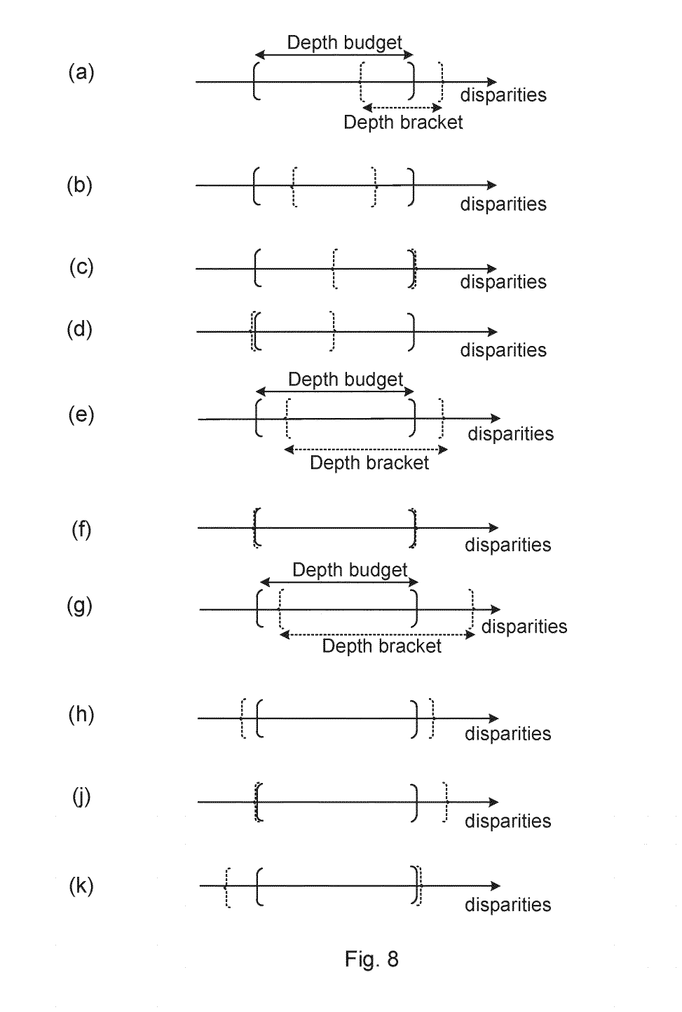

In the case the depth bracket is smaller than the depth budget (as in FIG. 8(a)), the shift is determined such that the depth bracket is contained within the depth budget, as is illustrated in FIGS. 8(b)-(d). Multiple solutions may thus be possible, since the depth bracket may be contained in the depth budget at different positions, as also shown in the FIGS. 8(b)-(d). The depth bracket may be chosen to be in the middle on the depth budget (as in FIG. 8(b)), where the 3D user experience may be the most comfortable. According to one embodiment the processing unit 3, 10 is thus further arranged to, in an optional step S108b, determine the positional displacement such that the depth bracket is completely contained within the depth budget. These instructions may be provided by the determining units 4b, 11b. Hence the determining units 4b, 11b may be configured to determine the positional displacement in this way. The computer program 14 and/or computer program product 13 may thus comprise means for performing instructions according to step S108b.

In the case the depth bracket is the same as the depth budget (as in FIG. 8(e)), only one solution is possible, as shown in FIG. 8(f).

In the case the depth bracket is larger than the depth budget (as in FIG. 8(g)), a trade-off is required since the depth bracket may not be fully contained in the depth budget. There are also multiple possibilities depending on whether one wants objects with rather positive or negative parallax, as shown in FIGS. 8(h)-(k). According to one embodiment the processing unit 3, 10 is thus further arranged to, in an optional step S108c, determine the positional displacement such that the depth budget is completely contained within the depth bracket. These instructions may be provided by the determining units 4b, 11b. Hence the determining units 4b, 11b may be configured to determine the positional displacement in this way. The computer program 14 and/or computer program product 13 may thus comprise means for performing instructions according to step S108c.

The depth bracket may be centered with the depth budget so that most of the central points are contained within the depth budget (as in FIG. 8(h)). On the other hand, if by other methods it is considered that after the shift the 3D user experience is still very poor, the system may determine to fall back to rendering of a 2D video for the user's sake.

On-Call Modifications

During the call, the scene of one of the clients may change, e.g. if a new object is introduced to the scene captured by the capturing unit 6. Depending on the location of such a new object (i.e. depending on its depth, Z_{object}), the depth bracket range for this client may also change, either because the new object is too close or too far from the capturing unit 6 (i.e. Z_{object}<Zₘᵢₙ or Z_{object}>Zₘₐₓ respectively).

In order to detect these cases, a periodical check of the depth bracket values may be carried out at each client during the call. According to one embodiment the processing unit 3, 10 is thus further arranged to, in an optional step S116, periodically check for a change of the depth bracket of the 3D video sequence. These instructions may be provided by the checking units 4f, 11f. Hence the checking units 4f, 11f may be configured to periodically check for this change. The computer program 14 and/or computer program product 13 may thus comprise means for performing instructions according to step S116. If the depth bracket is the same as the previous check (and therefore as the one stored in the central controller data base), then nothing happens. However, if a change in the depth bracket is detected, then the clients again requests the content of the central controller data base with the displays widths and depth budgets, and re-determines all the shifts as disclosed above. The updated shift list is therefore transmitted together with the 3D video sequences to the other clients, which individually adapt their received 3D video sequences according to the new value(s).

Disconnection

Finally, when a client is disconnected from the multi-party call, in addition to performing a common disconnect procedure, the processing unit 10 of the central controller erases the data of the thus disconnected client in the data base. In the case the central controller transmits an update to the clients when the data base is modified, then the clients will also erase the shift from their local lists. Conversely, if the central controller is a passive entity, then nothing will happen with the clients' lists.

### Second Overall Embodiment

FIG. 12 is a flowchart of methods according to the second overall embodiment (where CC is short for central controller). The second overall embodiment may be divided into four main parts: an initial phase where rendering capabilities are stored for subsequent adaptation of the 3D video sequence; a shift determination; on-call modifications; and disconnection. The processing of the second overall embodiment is as follows:

Initial Phase

The first video conferencing client device (hereinafter a first client, as represented by a first video conferencing client device 2a) requests a connection to a multi-party video conference. The connection request is sent by the communications interface 5 of the electronic devices 2a representing the first video conferencing client device. The connection request may be sent to an electronic device 9 representing a central controller, such as an MRFP.

The first client and the central controller negotiate connection properties, such as audio and video codecs, for example through SIP/SDP (Session Initiation Protocol/Session Description Protocol) negotiation or according to other protocols, such as H.323.

The central controller also assigns the first client with a unique ID, e.g. “client 1”. The central controller stores the client ID in the memory 11.

The first client starts transmitting the captured video to the central controller. Thus, a 3D video sequence is captured by the capturing unit 6 of the electronic devices 2a representing the first video conferencing client device 2a and the transmitted by its communications interface 5. The 3D video sequence is then received through the communications interface 12 of the electronic devices 9 representing the central controller. At this point it is, however, assumed that no other clients are connected to the 3D video conference. The central controller may thus disregard the received 3D video sequence and not transmit any 3D video sequences to the clients. For example, the processing unit 3 may be arranged to, on the rendering unit 7, display a message indicating the lack of other connected clients.

Then another client (hereinafter a second client, as represented by a second video conferencing client device 2b) requests a connection to the central controller.

The same SIP/SDP negotiation (or any other negotiation protocol) takes place between the central controller and the second client. Then, the central controller assigns the second client with a unique ID, e.g. “client 2” or “client N”.

As the skilled person understands, also at least one further client may join the 3D video conference according to the steps as outlined above.

The central controller routes/switches the 3D video sequences to the correct client(s).

The client receives a 3D video sequence and check whether the client ID of the received 3D video sequence is included in the list of shifts. If the client ID is in the list, the client proceeds as will further disclosed below. If the client ID is not in the list, the client transmits a message through e.g. the RTCP protocol to the client whose ID is not in the list for the client whose ID is not in the list also to transmit its depth bracket, for example during a certain number of frames.

The requested client (i.e., the client whose ID is not in the list) determines hence its depth bracket and encloses this information as metadata, e.g. in SEI message(s) of the video codec.

The requesting client (i.e., the client receiving a 3D video sequence) receives the information and, based on its own rendering capabilities (i.e. display width and depth budget), determines the shift needed for this particular client ID. Then the requesting client saves the client ID and the shift in its local list.

When all shifts are determined, the clients need only to transmit their 3D video sequences which are routed/switched by the central controller to the correct clients.

Thus, if a client receives the depth bracket together with a 3D video sequence, the client will only consider the metadata if the client has to determine the shift. It may ignore such metadata when no determination is needed.

A variation within the second overall embodiment concerns where the depth bracket (or produced disparity range) is determined. As outlined above, the transmitting client determined its own depth bracket and transmitted it as metadata. This requires a communication between transmitting and receiving clients. Nevertheless, since the transmitting client is transmitting the 3D video sequence, the depth bracket could be also determined at the receiving client. Although no communication is required between the clients in this case (the entire depth bracket determination is handled at the receiving client), the receiving client still needs to determine the depth bracket for all the received 3D video sequences. This implies more processing requirements for the receiving client.

The variation within the second overall embodiment will now be disclosed in more detail.

The first video conferencing client device (hereinafter a first client, as represented by a first video conferencing client device 2a) requests a connection to a multi-party video conference. The connection request is sent by the communications interface 5 of the electronic devices 2a representing the first video conferencing client device. The connection request may be sent to an electronic device 9 representing a central controller, such as an MRFP.

The first client and the central controller negotiate connection properties, such as audio and video codecs, for example through SIP/SDP (Session Initiation Protocol/Session Description Protocol) negotiation or according to other protocols, such as H.323.

The central controller also assigns the first client with a unique ID, e.g. “client 1”. The central controller stores the client ID in the memory 11.

The first client starts transmitting the captured video to the central controller. Thus, a 3D video sequence is captured by the capturing unit 6 of the electronic devices 2a representing the first video conferencing client device 2a and the transmitted by its communications interface 5. The 3D video sequence is then received through the communications interface 12 of the electronic devices 9 representing the central controller. At this point it is, however, assumed that no other clients are connected to the 3D video conference. The central controller may thus disregard the received 3D video sequence and not transmit any 3D video sequences to the clients. For example, the processing unit 3 may be arranged to on the rendering unit 7 display a message indicating the lack of other connected clients.

Then another client (hereinafter a second client, as represented by a second video conferencing client device 2b) requests a connection to the central controller.

The same SIP/SDP negotiation (or any other negotiation protocol) takes place between the central controller and the second client. Then, the central controller assigns the second client with a unique ID, e.g. “client 2” or “client N”.

As the skilled person understands, also at least one further client may join the 3D video conference according to the steps as outlined above.

The client receives a 3D video sequence and check whether the client ID of the received 3D video sequence is included in the list of shifts. If the client ID is in the list, the client proceeds as will further disclosed below. If the client ID is not in the list, the client determines the depth bracket of the received 3D video sequence.

Then, the receiving client determines the shift needed for this particular client ID based on the determined depth bracket and its own rendering capabilities (i.e. display width and depth budget). Then the receiving client saves the client ID and the shift in its local list.

The central controller keeps routing/switching the 3D video sequences to the correct client(s).

Shift Calculation

The strategies to determine the shift are the same as in the first overall embodiment as disclosed above. First the depth budget and depth bracket are converted into depth parameter values associated with the rendering side.

On-Call Modifications

During the call, the scene of one of the clients may change, e.g. if a new object is introduced to the scene captured by the capturing unit 6. Depending on the location of such a new object (i.e. depending on its depth, Z_{object}), the depth bracket range for this client may also change, either because the new object is too close or too far from the capturing unit 6 (i.e. Z_{object}<Zₘᵢₙ or Z_{object}>Zₘₐₓ respectively).

In order to detect these cases, a periodical check of the depth bracket values may be carried out at each client during the call. According to one embodiment the processing unit 3, 10 is thus further arranged to, in an optional step S116, periodically check for a change of the depth bracket of the 3D video sequence. These instructions may be provided by the checking units 4f, 11f. Hence the checking units 4f, 11f may be configured to periodically check for this change. The computer program 14 and/or computer program product 13 may thus comprise means for performing instructions according to step S116.

If the periodical check (and hence the depth bracket determination) is performed at the transmitting side and a depth bracket modification is detected, the client may transmit a message (e.g. through RTCP messages) to the other clients where the client informs that its depth bracket has been modified. Likewise, the client transmit its new depth bracket value (e.g. in SEI messages) together with its captured 3D video sequence, so that the other clients can re-determine the corresponding shift (as disclosed with reference to the first overall embodiment). The local list is finally updated with the new depth bracket value.

Alternatively, if the periodical check (and hence the depth bracket determination) is performed at the receiving side and a depth bracket modification is detected, the client automatically determines the depth bracket for the received 3D video sequence. Then, the client determines the new shift (as disclosed with reference to the first overall embodiment) and updates its own shift list with the new depth bracket value.

If the depth bracket is the same as the previous check, then nothing happens.

Disconnection

Finally, when a client is disconnected from the multi-party call, in addition to performing a common disconnect procedure, nothing will happen with the clients' lists.

### Third Overall Embodiment

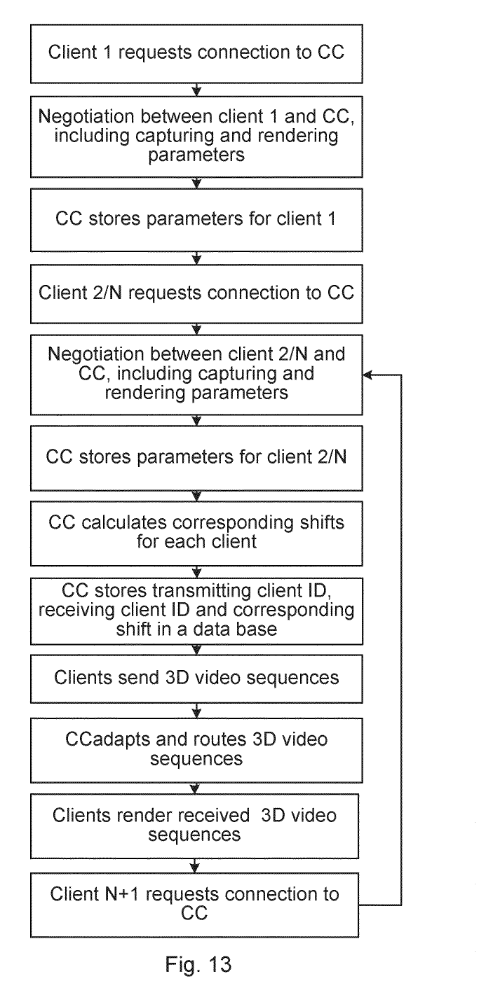

FIG. 13 is a flowchart of methods according to the third overall embodiment (where CC is short for central controller). The third overall embodiment may be divided into four main parts: an initial phase where rendering capabilities are stored for subsequent adaptation of the 3D video sequence; a shift determination; on-call modifications; and disconnection. The processing of the third overall embodiment is as follows:

Initial Phase

The first video conferencing client device (hereinafter a first client, as represented by a first video conferencing client device 2a) requests a connection to a multi-party video conference. The connection request is sent by the communications interface 5 of the electronic devices 2a representing the first video conferencing client device. The connection request may be sent to an electronic device 9 representing a central controller, such as an MRFP.

The first client and the central controller negotiate connection properties, such as audio and video codecs, for example through SIP/SDP (Session Initiation Protocol/Session Description Protocol) negotiation or according to other protocols, such as H.323. During the negotiation, the first client also signals its rendering capabilities (i.e. its 3D screen width, W_{D}) and/or the depth budget for this screen (i.e. Pₘᵢₙ and Pₘₐₓ). If the depth budget is not signaled, then the central controller considers a default case which corresponds to Pₘₐₓ=tₑ and Pₘᵢₙ=tₑ−Z_{D}·Δαₜₒₜₐₗ where Z_{D} is an either known or estimated display parameter (as described above). Likewise, the first client signals its capturing capabilities (if required) and its calculated depth bracket (or produced disparity range).

The central controller also assigns the first client with a unique ID, e.g. “client 1”. The central controller stores the client ID in the memory 11. Once the connection between the first client and the central controller is performed, the central controller stores the values of W_{D}, Pₘᵢₙ and Pₘₐₓ (if available) for this client ID in a remote data base (until other clients are connected).

The first client starts transmitting the captured video to the central controller. Thus, a 3D video sequence is captured by the capturing unit 6 of the electronic devices 2a representing the first video conferencing client device 2a and the transmitted by its communications interface 5. The 3D video sequence is then received through the communications interface 12 of the electronic devices 9 representing the central controller. At this point it is, however, assumed that no other clients are connected to the 3D video conference. The central controller may thus disregard the received 3D video sequence and not transmit any 3D video sequences to the clients. For example, the processing unit 3 may be arranged to on the rendering unit 7 display a message indicating the lack of other connected clients.

Then another client (hereinafter a second client, as represented by a second video conferencing client device 2b) requests a connection to the central controller.

The same SIP/SDP negotiation (or any other negotiation protocol) takes place between the central controller and the second client. That is, the second client also signals its rendering capabilities (i.e. its 3D screen width, W_{D}) and/or the depth budget for this screen (i.e. Pₘᵢₙ and Pₘₐₓ). Likewise, if the depth budget is not signaled, then the central controller considers the default case which corresponds to Pₘₐₓ=tₑ and Pₘᵢₙ=tₑ−Z_{D}·Δαₜₒₜₐₗ where Z_{D} is an either known or estimated display parameter (as described above). The second client also signals its capturing capabilities (if required) and its calculated depth bracket. Then, the central controller assigns the second client with a unique ID, e.g. “client 2” or “client N”.

Once the connection between the second client and the central controller is performed, the central controller stores the values of W_{D}, Pₘᵢₙ and Pₘₐₓ (if available) for this client ID in the remote data base.

As the skilled person understands, also at least one further client may join the 3D video conference according to the steps as outlined above.

At this point, the central controller recognizes that data from new clients has been stored in the data base. Therefore, the central controller determines the corresponding shifts (as described above, for example according to the first or second overall embodiment, mutatis mutandis). For example, in the case of two connected clients, the central controller determines a first shift from the first client to the second client and a second shift from the second client to the first client.

The central controller stores in a different data base the transmitting client, the receiving client and the shift to be applied.

The central controller then receives 3D video sequences from each client. The central controller decodes the 3D video sequences, applies to each 3D video sequence the determined shifts as dependent on the transmitting and receiving clients, respectively, and encodes each 3D video sequence again for transmission to the correct client.

The clients receive therefore adapted 3D video sequences to be directly rendered.

Shift Calculation

The strategies to determine the shift are the same as in the first overall embodiment as disclosed above. First the depth budget and depth bracket are converted into depth parameter values associated with the rendering side.

On-Call Modifications

During the call, the scene of one of the clients may change, e.g. if a new object is introduced to the scene captured by the capturing unit 6. Depending on the location of such a new object (i.e. depending on its depth, Z_{object}), the depth bracket range for this client may also change, either because the new object is too close or too far from the capturing unit 6 (i.e. Z_{object}<Zₘᵢₙ or Z_{object}>Zₘₐₓ respectively).

In order to detect these cases, a periodical check of the depth bracket values may be carried out at each client during the call. According to one embodiment the processing unit 3, 10 is thus further arranged to, in an optional step S116, periodically check for a change of the depth bracket of the 3D video sequence. These instructions may be provided by the checking units 4f, 11f. Hence the checking units 4f, 11f may be configured to periodically check for this change. The computer program 14 and/or computer program product 13 may thus comprise means for performing instructions according to step S116. If the depth bracket is the same as the previous check (and therefore as the one stored in the central controller data base), then nothing happens. However, if a change in the depth bracket is detected, then the clients informs the central controller thereof, and the central controller updates the data base with the displays widths and depth budgets, and re-determines all the shifts as disclosed above and stores the shifts in the second data base.

Disconnection

Finally, when a client is disconnected from the multi-party call, in addition to performing a common disconnect procedure, the processing unit 10 of the central controller erases the data of the thus disconnected client in both data bases.

A 3D video conference system 1 may comprise at least two electronic devices according to any one of the herein disclosed embodiments.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-18. (canceled)

19. A method for enabling adaptation of a 3D video sequence, the comprising an electronic device:
acquiring a 3D video sequence, the 3D video sequence comprising left and right views of image pairs;
acquiring a capturing parameter of the 3D video sequence;
acquiring a rendering capability parameter of a rendering device;
determining a positional displacement between the left and right views of the image pairs in the 3D video sequence based on the acquired rendering capability parameter and the acquired capturing parameter so as to enable adaptation of the 3D video sequence to the rendering device; and
providing the 3D video sequence and the positional displacement to at least one of the rendering unit and a controller.

20. The method of claim 19 further comprising:
adapting the 3D video sequence based on the positional displacement so as to generate an adapted 3D video sequence; and
rendering the adapted 3D video sequence.

21. The method of claim 19 wherein the 3D image sequence is acquired from a capturing device having captured the 3D image sequence.

22. The method of claim 19 wherein the 3D image sequence is acquired from a central controller.

23. The method of claim 19 wherein the rendering capability parameter is acquired from the controller.

24. The method of claim 19 wherein the capturing parameter is based on a depth bracket of the 3D image sequence.

25. The method of claim 19 wherein the rendering capability parameter is based on at least one of a screen size and a depth budget of the rendering device.

26. The method of claim 24:
wherein the rendering capability parameter is based on at least one of a screen size and a depth budget of the rendering device;
wherein the determining the positional displacement comprises comparing the depth budget of the rendering device with the depth bracket of the 3D video sequence as produced by the capturing device of the 3D video sequence.

27. The method of claim 26, further comprising determining the positional displacement such that the depth bracket is completely contained within the depth budget.

28. The method of claim 26, further comprising determining the positional displacement such that the depth budget is completely contained within the depth bracket.

29. The method of claim 19 further comprising periodically checking for a change of depth bracket of the 3D video sequence.

30. The method claim 19 wherein the method is performed in real-time.

31. An electronic device for enabling adaptation of a 3D video sequence, the electronic device comprising:
a processing circuit, the processing circuit configured to:
acquire a 3D video sequence, the 3D video sequence comprising left and right views of image pairs;
acquire a capturing parameter of the 3D video sequence;
acquire a rendering capability parameter of a rendering device;
determine a positional displacement between the left and right views of the image pairs in the 3D video sequence based on the acquired rendering capability parameter and the acquired capturing parameter so as to enable adaptation of the 3D video sequence to the rendering device; and
provide the 3D video sequence and the positional displacement to at least one of the rendering unit and a controller.

32. The electronic device of claim 31, further comprising at least one of:
a 3D video sequence capturing circuit configured to capture the 3D video sequence; and
a 3D video sequence rendering circuit configured to render the 3D video sequence.

33. The electronic device of claim 31, further comprising a communications interface configured to:
receive the 3D video sequence from a 3D video sequence capturing circuit device; and
transmit the 3D video sequence to a 3D video sequence rendering circuit device.

34. A 3D video conference system, comprising:
a first electronic device for enabling adaptation of a 3D video sequence, the first electronic device comprising, the first electronic device comprising a first processing circuit, the first processing circuit configured to:
acquire a 3D video sequence, the 3D video sequence comprising left and right views of image pairs;
acquire a capturing parameter of the 3D video sequence;
acquire a rendering capability parameter of a rendering device;
determine a positional displacement between the left and right views of the image pairs in the 3D video sequence based on the acquired rendering capability parameter and the acquired capturing parameter so as to enable adaptation of the 3D video sequence to the rendering device; and
provide the 3D video sequence and the positional displacement to at least one of the rendering unit and a controller.
a second electronic device for enabling adaptation of a 3D video sequence, the second electronic device comprising, the second electronic device comprising a second processing circuit, the second processing circuit configured to:
acquire a 3D video sequence, the 3D video sequence comprising left and right views of image pairs;
acquire a capturing parameter of the 3D video sequence;
acquire a rendering capability parameter of a rendering device;
determine a positional displacement between the left and right views of the image pairs in the 3D video sequence based on the acquired rendering capability parameter and the acquired capturing parameter so as to enable adaptation of the 3D video sequence to the rendering device; and
provide the 3D video sequence and the positional displacement to at least one of the rendering unit and a controller.

35. A computer program product stored in a non-transitory computer readable medium for enabling adaptation of a 3D video sequence, the computer program product comprising software instructions which, when run on a processing circuit of an electronic device, causes the electronic device to:
acquire a 3D video sequence, the 3D video sequence comprising left and right views of image pairs;
acquire a capturing parameter of the 3D video sequence;
acquire a rendering capability parameter of a rendering device;
determine a positional displacement between the left and right views of the image pairs in the 3D video sequence based on the acquired rendering capability parameter and the acquired capturing parameter so as to enable adaptation of the 3D video sequence to the rendering device; and
provide the 3D video sequence and the positional displacement to at least one of the rendering unit and a controller.
